(19) United States
(12) Patent Application Publication
(10) Pub. No.: US 2022/0172136 A1
(43) Pub. Date: Jun. 2, 2022

(54) SYSTEM FOR ANALYZING CHARACTERISTICS OF INTERNET OF SERVICES

(71) Applicant: Harbin University of Commerce, Harbin City (Heilongjiang Province) (CN)

(72) Inventors: Shizhen BAI, Harbin City (CN); Zongwei REN, Harbin City (CN)

(21) Appl. No.: 17/540,100

(22) Filed: Dec. 1, 2021

(30) Foreign Application Priority Data
Dec. 2, 2020 (CN) 202011405825.3

(51) Int. Cl. G06Q 10/06; G06F 17/40; G06Q 10/04

(52) U.S. Cl. CPC G06Q 10/06311; G06Q 10/04; G06F 17/40

(57) ABSTRACT

The present disclosure provides a system for analyzing characteristics of the Internet of services, the system including: a service business assignment management system configured for service business configuration management and scheduling based on configured service business data; a service business management system configured to process a service business transaction and encapsulate service business data and execute a service business based on service business transaction data to be processed; a man-machine interaction interface configured to implement information interaction between a platform and a user and display information; a cloud data center configured to perform analysis and processing based on the service business data to implement scheduling of various data; an application service system configured for data interaction with the service business assignment management system and the service business management system to implement integration and services of different applications; and a data access system configured to carry data interconnection between various systems.

### CROSS REFERENCE TO RELATED APPLICATION

This patent application claims the benefit and priority of Chinese Patent Application No. 202011405825.3, filed on Dec. 02, 2020, the disclosure of which is incorporated by reference herein in its entirety as part of the present application.

### TECHNICAL FIELD

The present disclosure relates to the field of Internet technologies, and in particular, to a system for analyzing characteristics of the Internet of services.

### BACKGROUND ART

In recent years, domestic and foreign research institutions and scholars have done a lot of researches on the structure and behavioral characteristics of the Internet of services. James F. Moore proposed the concept of the service ecosystem in 1993. Mirva Peltoniemi gave basic definitions for features such as self-organization, co-evolution, and adaptability of the service ecosystem, and established a service network model. Pingfeng Liu believes that the service ecosystem is a typical complex adaptive system featuring openness, dynamics, and adaptability. Rahul C Basole et al. believe that the service ecosystem is a value-based system, and the structure and changes of a service value network have an important impact on the service ecosystem itself. However, the current researches mainly focus on the external structure and behavioral characteristics of the Internet of services, and there is a lack of systematic theoretical analysis and tools for the formation mechanism, system model, and architecture of the Internet of services.

### SUMMARY

In view of this, the present disclosure provides a system for analyzing characteristics of the Internet of services, to improve data transmission performance and accuracy of business assignment and classification.

To achieve the foregoing objective, the present disclosure provides a system for analyzing characteristics of the Internet of services, the system including: a service business assignment management system, a service business management system, a man-machine interaction interface, a cloud data center, an application service system, and a data access system, where

the service business assignment management system is configured for service business configuration management and for scheduling based on configured service business data;

the service business management system is configured to process a service business transaction and encapsulate service business data and execute a service business based on service business transaction data to be processed;

the man-machine interaction interface is configured to implement information interaction between a platform and a user and display information;

the cloud data center is configured to perform analysis and processing based on the service business data to implement scheduling of various data;

the application service system is configured for data interaction with the service business assignment management system and the service business management system to implement integration and services of different applications; and

the data access system is configured to carry data interconnection between the service business assignment management system, the service business management system, the cloud data center, and the application service system.

Further, the cloud data center schedules the service business data correspondingly based on a type of the service business data, the type of the service business data including a life service type, an economic service type, and a travel service type.

Further, the cloud data center schedules the service business data to the corresponding application service system based on the type of the service business data, the application service system including a life service application system, an economic service application system, and a travel service application system.

Further, the man-machine interaction interface displays information by means of a display screen.

Compared with the related art, the present disclosure provides a system for analyzing characteristics of the Internet of services, the system including: a service business assignment management system, a service business management system, a man-machine interaction interface, a cloud data center, an application service system, and a data access system, where the service business assignment management system is configured for service business configuration management and for scheduling based on configured service business data; the service business management system is configured to process a service business transaction and encapsulate service business data and execute a service business based on service business transaction data to be processed; the man-machine interaction interface is configured to implement information interaction between a platform and a user and display information; the cloud data center is configured to perform analysis and processing based on the service business data to implement scheduling of various data; the application service system is configured for data interaction with the service business assignment management system and the service business management system to implement integration and services of different applications; and the data access system is configured to carry data interconnection between various systems. The present disclosure improves data transmission performance and accuracy of business assignment and classification.

### BRIEF DESCRIPTION OF THE DRAWINGS

FIG. 1 is a schematic diagram of a system for analyzing characteristics of the Internet of services according to an embodiment of the present disclosure.

### DETAILED DESCRIPTION OF THE EMBODIMENTS

The present disclosure will be further described in detail below with reference to the accompanying drawings and embodiments.

Architecture of the Internet of services: which, for features such as heterogeneity, autonomy, resemblance to ecology, and self-evolution of the Internet of services, studies the structure and form of the Internet of services in a complex business and service environment, and a perception/cognition and integration mechanism of massive service resources, and proposes an architecture and a simulation tool of the Internet of services in a multi-level and interdisciplinary massive heterogeneous service resource environment.

Convergent ecological model of the Internet of services: which theoretically analyzes a formation and development mechanism of the Internet of services, a community formation mechanism, and characteristics such as detectability and controllability of a system state, provides a convergent ecological model of the Internet of services, and systematically analyzes the form, nature, behavioral principle, and effect mechanism of the Internet of services.

Business integration model of the Internet of services for multilateral resource integration: which studies a synergy mechanism and service mode of business processes and service resources in the Internet-of-service environment, a cross-domain/boundary/platform/network service business integration model, and a large-scale personalized service customization and transaction theory and method.

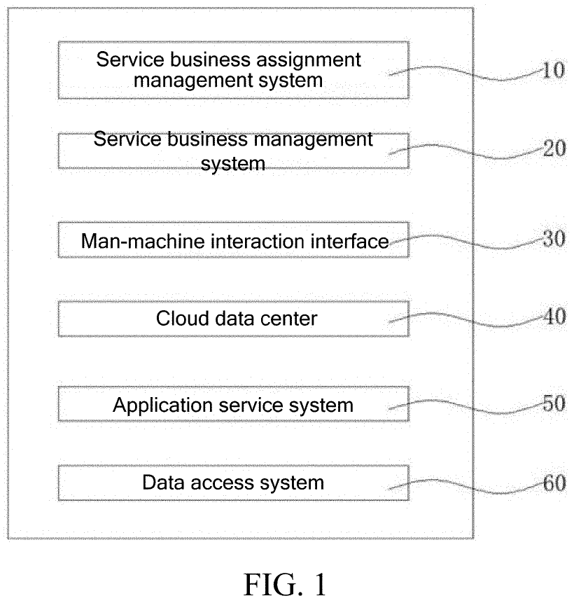

As shown in FIG. 1, the present disclosure provides a system for analyzing characteristics of the Internet of services, the system including: a service business assignment management system 10, a service business management system 20, a man-machine interaction interface 30, a cloud data center 40, an application service system 50, and a data access system 60.

The service business assignment management system 10 is configured for service business configuration management and for scheduling based on configured service business data, where the service business configuration management specifically refers to determination of a type and content of a service business.

The service business management system 20 is configured to process a service business transaction and encapsulate service business data and execute a service business based on service business transaction data to be processed.

The man-machine interaction interface 30 is configured to implement information interaction between a platform and a user and display information, where the man-machine interaction interface 30 displays information by means of a display screen.

The cloud data center 40 is configured to perform analysis and processing based on the service business data to implement scheduling of various data, where the cloud data center 40 schedules the service business data correspondingly based on a type of the service business data, the type of the service business data including a life service type, an economic service type, and a travel service type. The cloud data center 40 schedules the service business data to the corresponding application service system 50 based on the type of the service business data, the application service system 50 including a life service application system, an economic service application system, and a travel service application system.

The application service system 50 is configured for data interaction with the service business assignment management system 10 and the service business management system 20 to implement integration and services of different applications.

The data access system 60 is configured to carry data interconnection between the service business assignment management system 10, the service business management system 20, the cloud data center 40, and the application service system 50.

Finally, it should be noted that the foregoing embodiments are only used to illustrate the technical solutions of the present disclosure, and are not intended to limit same. Although the present disclosure is described in detail with reference to the foregoing embodiments, those of ordinary skill in the art should understand that they can still modify the technical solutions described in the foregoing embodiments, or make equivalent substitutions to some technical features therein. These modifications or substitutions do not make the essence of the corresponding technical solutions depart from the spirit and scope of the technical solutions of the embodiments of the present disclosure.

What is claimed is:

1. A system for analyzing characteristics of the Internet of services, comprising: a service business assignment management system, a service business management system, a man-machine interaction interface, a cloud data center, an application service system, and a data access system, wherein
the service business assignment management system is configured for service business configuration management and scheduling based on configured service business data;
the service business management system is configured to process a service business transaction, and encapsulate service business data and execute a service business based on service business transaction data to be processed;
the man-machine interaction interface is configured to implement information interaction between a platform and a user and display information;
the cloud data center is configured to perform analysis and processing based on the service business data to implement scheduling of various data;
the application service system is configured for data interaction with the service business assignment management system and the service business management system to implement integration and services of different applications; and
the data access system is configured to carry data interconnection between the service business assignment management system, the service business management system, the cloud data center, and the application service system.

2. The system for analyzing characteristics of the Internet of services according to claim 1, wherein the cloud data center schedules the service business data correspondingly based on a type of the service business data, the type of the service business data comprising a life service type, an economic service type, and a travel service type.

3. The system for analyzing characteristics of the Internet of services according to claim 2, wherein the cloud data center schedules the service business data to the corresponding application service system based on the type of the service business data, the application service system comprising a life service application system, an economic service application system, and a travel service application system.

4. The system for analyzing characteristics of the Internet of services according to claim 1, wherein the man-machine interaction interface displays information by means of a display screen.
